(19) United States
(12) Patent Application Publication
(10) Pub. No.: US 2010/0198742 A1
(43) Pub. Date: Aug. 5, 2010

(54) Online Social Encountering

(75) Inventors: Jack H. Chang, Saratoga, CA (US); Sherman Tuan, Cupertino, CA (US); William H. Sheu, Fremont, CA (US); Yiwen Tseng, Campbell, CA (US)

Correspondence Address: Nixon Peabody LLP, P.O. Box 60610, Palo Alto, CA, 94306, US

(73) Assignee: PurpleComm, Inc., Santa Clara, CA (US)

(21) Appl. No.: 12/365,050

(22) Filed: Feb. 3, 2009

(51) Int. Cl. G06Q 99/00; G06F 3/00; G06F 17/30; G06F 15/173

(52) U.S. Cl. 705/319; 715/753; 709/224; 707/E17.044

(57) ABSTRACT

A method for online social encountering includes obtaining identity information regarding a user of an online encounter service, and sending to a presence server, online presence information regarding the user. The method also includes receiving from the presence server, online presence information regarding one or more friends of the user that are visiting a website that the user is also visiting. If the user and the one or more friends indicate a desire to interact, an interaction between the user and the one or more friends is initiated.

### RELATED APPLICATIONS

This application may be related to one or more of the following commonly assigned United States Patent Applications filed on Feb. 20, 2008:

Ser. No. 12/070,771, entitled “Website Presence” (Attorney Docket No. 037273-000012);

Ser. No. 12/070,872, entitled “Collaborative Website Presence” (Attorney Docket No. 037273-000013); and

Ser. No. 12/070,770, entitled “Website Presence Marketplace” (Attorney Docket No. 037273-000014).

The related applications are hereby incorporated herein by reference as if set forth fully herein.

### FIELD OF THE INVENTION

The present invention relates to the field of computer science. More particularly, the present invention relates to online social encountering.

### BACKGROUND OF THE INVENTION

In the physical world, it is usually a pleasant surprise to run into an acquaintance at a public place such as a store or shopping mall. One might take such an opportunity to share shopping experiences with each other. Purchasing decisions are typically facilitated by the ability to share purchase or product experiences with an acquaintance. For example, if two people that know each other from playing in a local volleyball league bump into each other at a shopping mall, they might share their experiences shopping for volleyball shoes, and perhaps make their purchases at the same store in the shopping mall.

In the virtual world, the term “online social media” describes a space where a user's identity and relationship with a friend can be managed and stored. The types of media include instant messengers such as MSN Messenger, Yahoo! Messenger, and AIM, online social networks such as Facebook, MySpace, LinkedIn, and Twitter, social bookmarking networks such as Digg, Del.icio.us, and StumbleUpon, hobby groups such as iLike and Flixter, and address lists from email services such as Gmail and Yahoo! Mail.

A user's identity in the virtual world contains basic information about a user, such as name, nickname, date of birth, and marital status. A user's relationship with other users is typically represented in the form of buddy list or friend list.

Users in the virtual world may visit a variety of websites, for example a website for a clothing manufacturer. Unlike the physical world, users in the virtual world are typically not aware of other users visiting the same website.

A need exists in the prior art for a solution that allows friends in the virtual world to interact or “stumble upon” each other when the friends are visiting the same website.

### SUMMARY OF THE INVENTION

A method for online social encountering includes obtaining identity information regarding a user of an online encounter service, and sending to a presence server, online presence information regarding the user. The method also includes receiving from the presence server, online presence information regarding one or more friends of the user that are visiting a website that the user is also visiting. If the user and the one or more friends indicate a desire to interact, an interaction between the user and the one or more friends is initiated.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram that illustrates a system for online social encountering in accordance with one embodiment of the present invention.

FIG. 2 is a block diagram that illustrates a system for online social encountering having a web service resident within a cooperative site in accordance with one embodiment of the present invention.

FIG. 3 is a block diagram that illustrates a continuum of online encounter service integration levels in accordance with embodiments of the present invention.

FIG. 4 is a flow diagram that illustrates a method for relationship establishment from a user's perspective in a system for online social encountering in accordance with one embodiment of the present invention.

FIG. 5A is a block diagram that illustrates friend groupings based on third party social media service in accordance with one embodiment of the present invention.

FIG. 5B is a block diagram that illustrates friend groupings a user's real world association with the friends in accordance with one embodiment of the present invention.

FIG. 6 is a flow diagram that illustrates privacy controls in a system for online social encountering in accordance with one embodiment of the present invention.

FIG. 7 is a flow diagram that illustrates a method for relationship establishment from the perspective of an online encounter service in a system for online social encountering in accordance with one embodiment of the present invention.

FIG. 8 is a flow diagram that illustrates a method for presence interaction from the perspective of a presence client in a system for online social encountering in accordance with one embodiment of the present invention.

FIG. 9 is a flow diagram that illustrates a method for presence interaction from the perspective of a presence server in a system for online social encountering in accordance with one embodiment of the present invention.

FIG. 10 is a flow diagram that illustrates a method for presence interaction from the perspective of an encounter server in a system for online social encountering in accordance with one embodiment of the present invention.

FIG. 11 is a block diagram that illustrates a presence list in accordance with one embodiment of the present invention.

FIG. 12 is a block diagram that illustrates a presence notification balloon in accordance with one embodiment of the present invention.

FIG. 13 is a block diagram of a computer system suitable for implementing aspects of the present invention.

### DETAILED DESCRIPTION

Embodiments of the present invention are described herein in the context of online social encountering. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general-purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “network” includes local area networks (LANs), wide area networks (WANs), metro area networks, residential networks, corporate networks, inter-networks, the Internet, the World Wide Web, cable television systems, telephone systems, wireless telecommunications systems, fiber optic networks, token ring networks, Ethernet networks, ATM networks, frame relay networks, satellite communications systems, and the like. Such networks are well known in the art and consequently are not further described here.

In the context of the present invention, the term “identifier” describes an ordered series of one or more numbers, characters, symbols, or the like. More generally, an “identifier” describes any entity that can be represented by one or more bits.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present invention, the term “data stores” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, repositories, file systems, record systems, object oriented databases, relational databases, SQL databases, audit trails and logs, program memory, cache and buffers, and the like.

In the context of the present invention, the term “network interface” describes the means by which users including website visitors access a network for the purposes of communicating across it or retrieving information from it.

In the context of the present invention, the term “user interface” describes any device or group of devices for presenting and/or receiving information and/or directions to and/or from persons. A user interface may comprise a means to present information to persons, such as a visual display projector or screen, a loudspeaker, a light or system of lights, a printer, a Braille device, a vibrating device, or the like. A user interface may also include a means to receive information or directions from persons, such as one or more or combinations of buttons, keys, levers, switches, knobs, touch pads, touch screens, microphones, speech detectors, motion detectors, cameras, and light detectors. Exemplary user interfaces comprise pagers, mobile phones, desktop computers, laptop computers, handheld and palm computers, personal digital assistants (PDAs), cathode-ray tubes (CRTs), keyboards, keypads, liquid crystal displays (LCDs), control panels, horns, sirens, alarms, printers, speakers, mouse devices, consoles, and speech recognition devices.

In the context of the present invention, the term “system” describes any computer information and/or control device, devices or network of devices, of hardware and/or software, comprising processor means, data storage means, program means, and/or user interface means, which is adapted to communicate with the embodiments of the present invention, via one or more data networks or connections, and is adapted for use in conjunction with the embodiments of the present invention.

In the context of the present invention, the term “website presence” describes one or more of the state of a website object regarding its participation in a communication session, the ability of the website object to participate in a communication session, and the willingness of the website object to participate in a communication session.

In the context of the present invention, the term “website object” describes a representation of an entity associated with a website. A website object may represent a visitor to the website. A website object may also represent an event associated with the website, such as a live demonstration session and a live question-and-answer session. By way of example, a vendor's website may feature a live question and answer session to answer questions about the vendor's products. An object may also comprise an interactive video session. By way of example, a vendor's website may feature a live demonstration session to demonstrate the operation of one or more of the vendor's products. The particular presence information of a website object that is tracked and published is configurable by the website object.

In the context of the present invention, the term “aggregated website presence” describes a collection of website presence information regarding multiple objects associated with the same website. The aggregated website presence information includes presence information of each website object, and website presence information that describes the collection of website objects as a whole. By way of example, the aggregated website presence information may include the website page viewing activity presence, discussion/forum/event presence, and sales activity presence.

In the context of the present invention, the term “subscriber” refers to an entity that requests access to particular website presence information. A subscriber may pay a fee in return for receiving all or part of the requested website presence information.

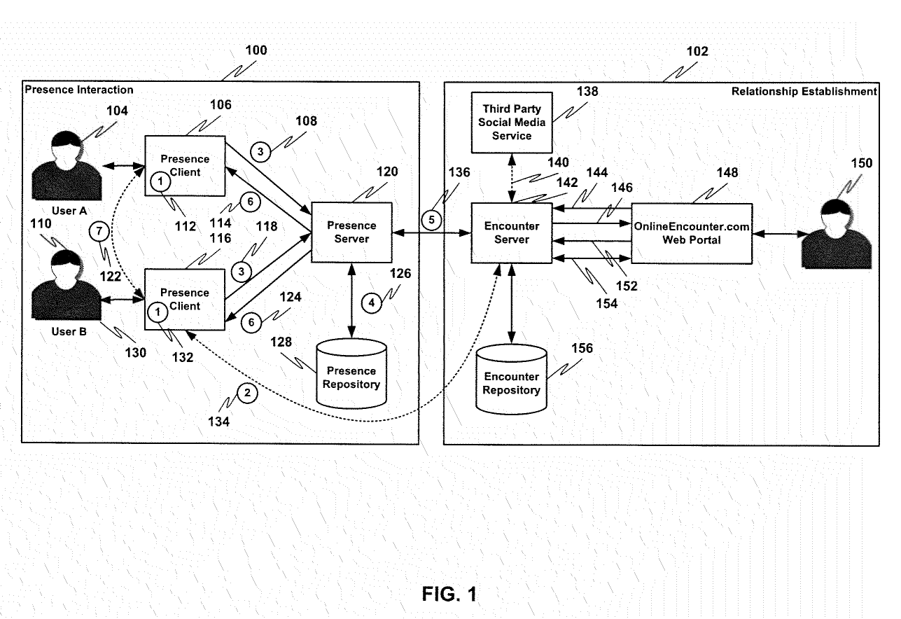

FIG. 1 is a block diagram that illustrates a system for online social encountering in accordance with one embodiment of the present invention. As shown in FIG. 1, a system for online social encountering comprises one or more presence clients (106, 116), a presence server 120, a presence repository 128, an encounter server 142, an encounter repository 156, and an online encounter web portal 148.

### Relationship Establishment

According to one embodiment of the present invention, a user 150 interested in an online social encountering experience registers with an online encounter service by providing the user's online social media identification and authentication information. For example, a user 150 that has accounts with third party social media services 138 such as MSN and Facebook would provide the user's MSN account and password and the user's Facebook ID and password. The user 150 may register with the online encounter service through an online encounter service web portal 148. A cookie containing user's online encounter service (e.g. OnlineEncounter.com) identity information can be stored on the user's computer for future use in identifying the user 150. Tightly integrated cooperative sites that are interested in the online encounter service may register their users' account information at the online encounter server 142 using one or more application program interfaces (APIs) provided by the online encounter service.

According to another embodiment of the present invention, a user 150 registers for the online encounter service and configures the online encounter services at a cooperative site, without requiring knowledge about a back-end online encounter server 142. In this scenario, the online encounter service receives user information via web service input from the cooperative site. The following table summarizes various ways for a user to register with an online encounter service.

TABLE 1

| | | Location Users |
|---|---|---|
| | | Go To Register/ |
| Technology | User Component Download | Configure |
| Web | No download | Cooperative site |
| service | | |
| Webpage | The user is asked to download a plug- | Online Encounter |
| Plug-In | in upon visiting the webpage having | Web Portal |
| | the plug-in embedded therein. The | |
| | same plug-in need not be downloaded | |
| | again upon visiting another webpage | |
| | having the same plug-in. | |
| JavaScript | No download | Online Encounter |
| | | Web Portal |
| Browser | Browser add-on is downloaded from a | Online Encounter |
| Add-on | partner site. Once installed, add-on is | Web Portal |
| | enabled when the user opens the web | |
| | browser. | |

### Friend List Retrieval and Privacy Control Configuration

According to one embodiment of the present invention, from either a user's direct input at an online encounter service web portal 148 or via a cooperative site's API input to the online encounter service, the online encounter service uses a user's account and password for each social media registered to retrieve that user's buddy list or friend list. The user 150 is presented with a list of friends retrieved from the social media 138, and the user 150 is allowed to configure one or more privacy controls for each friend. The user can also define a default privacy control setting and apply it to the selected friend.

According to one embodiment of the present invention, after a user 150 has established friend lists, the user 150 can take one or more of the following actions to protect the user's privacy. The user 150 can block a specific website or individual friend from a social encountering experience. The user 150 can also ask the online encounter service to prompt the user 150 regarding a privacy control to apply to a particular social encountering experience. A default privacy setting can be configured to apply for all new friends added in the future.

According to embodiments of the present invention, online encounter functionality may be implemented using a number of technologies, including web browser add-ons, web page plug-ins. These implementations are discussed in more detail below.

### Web Browser Add-On

According to one embodiment of the present invention, a user 150 downloads a web browser add-on from a partner website, enabling the user 150 to use online social encountering. The web browser add-on can be obtained from the online encounter service and any interested partner sites (i.e. whoever is willing to host the software component and make it available for download). Additionally, a Firefox online encounter service add-on can also be downloaded from a Mozilla Firefox add-on organization such as https://addons.mozilla.org. An Internet Explorer online encounter service add-on can be downloaded from an organization such as Windows Marketplace (www.windowsmarketplace.com). After the browser add-on is installed, the online encounter service web browser add-on program will run as long as the browser add-on is enabled in the browser.

### Webpage Plug-In and Embedded JavaScript

According to one embodiment of the present invention, upon visiting any page with an online encounter service component (i.e. webpage plug-in and embedded JavaScript) embedded therein, a user 150 is able to use the online counter service.

If a user 150 is visiting a cooperative website and the user 150 has an online encounter service web browser add-on installed as well, the user 150 may find an identical online social encountering experience provided, either through a browser add-on or a webpage plug-in/embedded JavaScript.

Referring again to FIG. 1, user 150 registers with an online encounter service 148. User 150 provides the online encounter service 148 with account information for one or more online social media services 138. User 150 receives a list of contacts received from one or more online social media services 138. User 150 optionally organizes the contacts into one or more groups. For example, the user 150 may organize the contacts into three groups: family members, contacts from school, and contacts from work. For at least one contact and at least one website, user 150 optionally indicates whether the contact may learn the user's presence when the user 150 is visiting the website.

Still referring to FIG. 1, online encounter server 142 is configured to receive registration information from user 150 via online encounter web portal 148. Online encounter server 142 is optionally configured to send a cookie to user 150's computer for use in future identification of the user 150. Online encounter server 142 is further configured to receive the user's account information for one or more online social media services 138. Online encounter server 142 is further configured to use the user's account information to retrieve a list of contacts from the one or more online social media services 138. Online encounter server 142 is further configured to render the list of contacts to the user 150. Online encounter server 142 is optionally configured to organize the contacts into one or more groups as indicated by the user 150. Online encounter server 142 is optionally configured to, for at least one contact and at least one website, receive an indication from the user 150 regarding whether the contact may learn the user's presence information when the user 150 is visiting the website.

According example embodiments of the present invention, presence client (106, 116) implements either a SIP SIMPLE or Jabber protocol to communicate the presence information either with presence server 120 or between peers. Presence information may be delivered to end users using a variety of approaches. Four example approaches are discussed below.

### Presence Information Delivery via Browser Add-On

According to one embodiment of the present invention, user (104, 110) downloads and installs a browser add-on from an online encounter web portal 148 or a partner site. A Firefox Web browser add-on may be implemented using a Mozilla extensions framework. An Internet Explorer Web browser add-on may be implemented as an Internet Explorer extension using features such as toolbars and browser helper objects. Once the browser add-on is enabled in the browser, the presence client program executes upon launching the browser.

### Presence Information Delivery via Webpage Plug-In

According to another embodiment of the present invention, a cooperative website embeds an online encounter service plug-in in the cooperative website's web pages. The webpage plug-in may be implemented with one core presence component but wrapped differently in various forms—ActiveX in Internet Explorer, or a Flash application. In an ActiveX application, users may be prompted regarding whether they to trust the site so that the application may be downloaded. In a Flash application, as long as a user has a Flash component installed in their Web browser, the user will be able to use the presence client without requiring an additional download.

### Presence Information Delivery via JavaScript Engine

According to another embodiment of the present invention, a JavaScript engine Cooperative website embeds JavaScript, such as AJAX, in the cooperative website web pages. The Online Encounter service may implement Comet technology, also known as server push or reverses Ajax, to push data from the presence server 120 to the presence client (106, 116) to update the latest presence information to a local Ajax client. An advantage of this approach is that since browsers typically support JavaScript, the present approach does not require a download.

According to one embodiment of the present invention, the JavaScript Engine Approach identifies a user by reading an online encounter service cookie planted on a users' computer by the online encounter service. A presence client (108, 116) implemented using the JavaScript engine approach communicates directly with the Onlilne Encounter server 142. If the embedded JavaScript cannot find an online encounter service cookie, a text message can be displayed, prompting a user to register and sign in with the online encounter service to enable a social online encountering experience. Users (104, 110) must register and login on the online encounter service before the embedded JavaScript in another website (e.g. Macys.com) knows a user's identity and is able to pass the user's activity information back and forth between the online encounter service.

### Presence Information Delivery via Web Service Residing on Cooperative Site

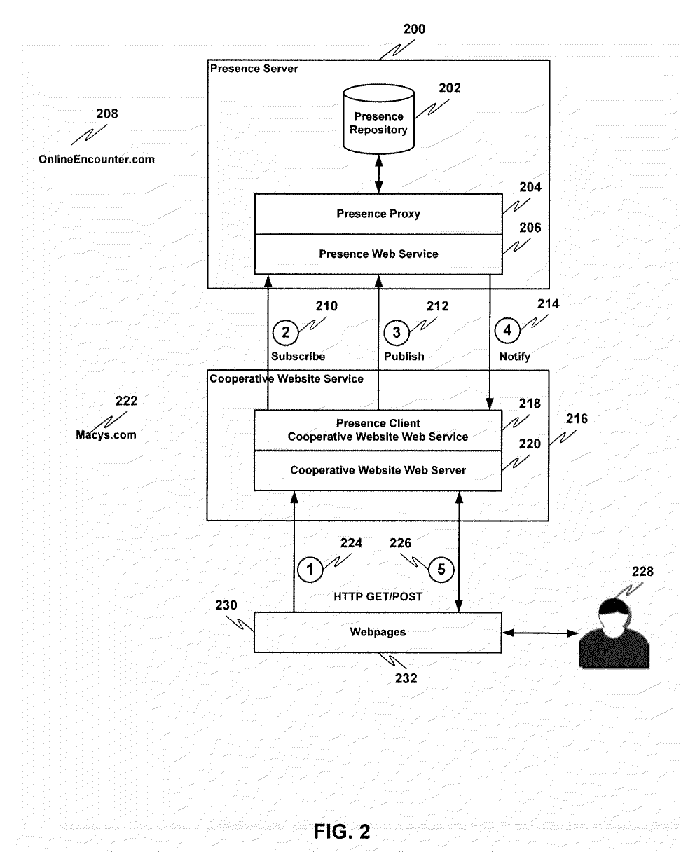

According to another embodiment of the present invention, a cooperative website uses a web service approach to work with an online encounter web service. The online encounter web service may provide APIs, such as SOAP and REST APIs. The cooperative website web service also provides APIs, such as SOAP or REST APIs, for an online encounter service to call back. This approach is discussed in more detail below, with reference to FIG. 2.

According to one embodiment of the present invention, presence server 120 implements SIP SIMPLE and a Jabber protocol to communicate the presence information with presence clients. While the presence server 120 maintains the cache of all the presence status except offline status of all users (i.e. any user that is not online), Presence repository 128 stores the same set of presence data in the backend representing a robust persistence layer.

According to one embodiment of the present invention, online encounter server 142 stores user input information. The user input information may include online encounter service identity, third party online social media service identity, relationship from third party services, and privacy setting.

According to one embodiment of the present invention, users (104, 110) can store their various online social media identities with the online encounter service, thus allowing the online encounter service to be able to update a user's relationship periodically without requiring the user's manual input each time. Alternatively, users (104, 110) may choose to not store the user's other online social media identities with an online encounter service. If the user (104, 110) chooses to not store the user's online social media identities, the online encounter service may store a timer in online encounter repository 156 to remind users (104, 110) of the last time they obtained updated information from the third party social media services 138.

According to one embodiment of the present information, online encounter service web portal 148 is for use by a user 150 in registering for an online encounter service account. Online encounter service web portal 148 may also be used by user 150 to manage and configure the user's online encounter service identity, relationship and privacy information.

### Presence Interaction

According to one embodiment of the present invention, presence client (106, 132) is configured to obtain identity information regarding a user (104, 110) of an online encounter service. Presence client (106, 132) is further configured to send online presence information regarding the user (104, 110) to a presence server 120. The presence information includes site identity, user identity, and user presence status. Presence client (106, 132) is further configured to receive from the presence server 120, online presence information regarding one or more friends of the user (104, 110) that are visiting the same website as the user (104, 1 10). Presence client (106, 132) is further configured to determine whether the user (104, 110) wants to interact with a particular friend. Presence client (106, 132) is further configured to, if the determination indicates the user (104, 110) wants to interact with the friend, determine whether the friend wants to interact with the user (104, 110). Presence client (106, 132) is further configured to, if it is determined that the friend wants to interact with the user (104, 110), initiate interaction between the user (104, 110) and the friend.

Presence server 120 is configured to receive online presence information regarding a user (104, 110) of an online encounter service. Presence server 120 is further configured to store the online presence information. Presence server 120 is further configured to send the online presence information to an encounter server 142. Presence server 120 is further configured to receive a list of friends with whom the user (104, 110) would like to interact. Presence server 120 is further configured to determine whether there are any friends in the list that are visiting the same website as the user. Presence server 120 is further configured to, if it is determined that there are one or more friends in the list that are visiting the same website as the user, send the user's online presence information to all friends in the list who are visiting the same website as the user (104, 110), and who are allowed to see the other user's activities.

From the perspective of a presence server 120, online presence information regarding a user (104, 110) of an online encounter service is received. The online presence information is stored. The online presence information is sent to an encounter server 142. A list of friends the user (104, 110) would like to interact with is received. A determination is made regarding whether there are any friends in the list that are visiting the same website as the user (104, 110). If it is determined that there are one or more friends in the list that are visiting the same website as the user (104, 110), the user's online presence information is sent to all friends in the list who are visiting the same website as the user (104, 110), and who are allowed to see the other user's activities.

According to one embodiment of the present invention, encounter server 142 is configured to receive online presence information regarding a user of an online encounter service is received. Encounter server 142 is further configured to send a list of friends the user (104, 110) would like to interact with.

FIG. 2 is a block diagram that illustrates a system for online social encountering having a web service resident within a cooperative site in accordance with one embodiment of the present invention. As shown in FIG. 2, at 224 a user 228 visits cooperative website Macys.com 222. At 210, Macys.com 222 subscribes to the online encounter service 208 presence information on behalf of user 228. At 212, Macys.com 222 publishes online presence information on behalf of user 228. At 214, presence web service 206 of the online encounter service presence server 200 delivers other users' presence information to cooperative site's web services 218. At 226, a cooperative website 222 displays presence information on its web pages based on the presence information it receives from its presence client 218, the cooperative website web service 218.

According to embodiments of the present invention, the level of integration between an online encounter service and a website ranges from loosely integrated to tightly integrated. In a tightly integrated scenario, website owners can define their presence status content themselves and pass to the information to an online encounter server 142. A cooperative site may inform the online encounter service of a user's presence status via a web service API. The online encounter server 142 retains no knowledge of the presence status; it simply passes such information through. The presence status can be any site owner-defined status, such as “shopping” or “check out” or “browsing certain product” or “browsing certain topic”; the status is defined by cooperative sites.

For loosely integrated cooperative sites and non-cooperative sites, the online encounter service predefines online and offline (of a website) status, and the website and webpage title the user is visiting.

Regardless of the form of the presence client and different website integration level with the online encounter service, a user will see presence status shown on the user's presence client. Although the presence clients of non-tightly-integrated websites are unable to send out a customized presence status to the online encounter server 142, the customized presence information from a tightly integrated cooperative site can be passed to any type of presence client, and the presence client simply displays the information it receives.

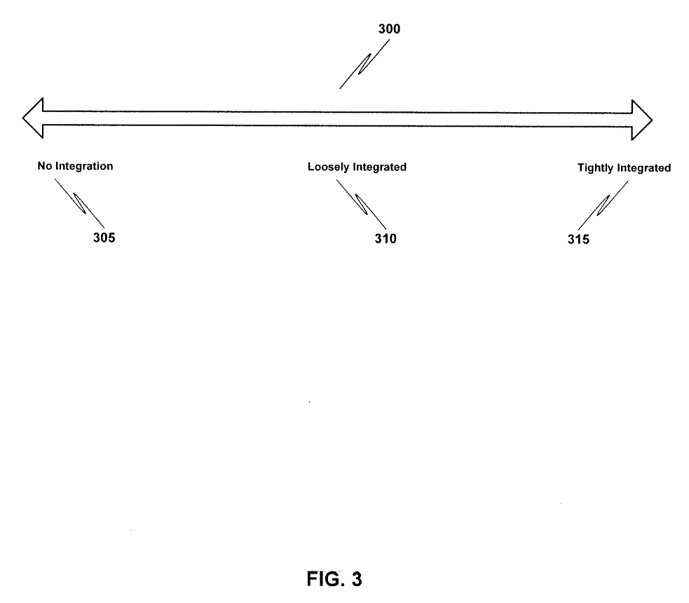

FIG. 3 is a block diagram that illustrates a continuum of online encounter service integration levels in accordance with embodiments of the present invention. A website where online users could stumble upon each other may be categorized as a cooperative site or a as a non-cooperative site, depending on the integration level of the website. A cooperative site is a website with some level of integration of the “Online Social Encounter” technology. According to one embodiment of the present invention, there are three levels of integration that an online social encounter service provides with its Cooperative Site partners: no integration, loosely integrated and tightly integrated. These two levels of integration are discussed in more detail below.

### No Integration

A non-cooperative site is a website running without any integration with an online encounter service server, and no special code is embedded in its web pages. A user must download a web browser add-on to facilitate online social encountering for a noncooperative site.

### Loosely Integrated

In a loosely integrated scenario, a cooperative site incorporates certain Online Social Encounter technology components such as a webpage plug-in or JavaScript code, which may be provided by the online encounter service, and embeds the components into its web pages. This level of integration does not require the cooperative site to have a website account with the online encounter service; a site owner merely needs to embed the selected components into the site's web pages.

### Tightly Integrated

In a tightly integrated scenario, the cooperative website owners registers a website account with the online encounter service. With access to APIs of the online encounter service, a cooperative site can interact with online encounter services on the cooperative website user's behalf, using a site ID assigned by the online encounter service, a site authentication token and the cooperative website user information. This interaction and integration is done on server side of web services of the online encounter service and the cooperative site. Such a tightly integrated scenario allows a more customized user experience for cooperative site users.

The following table illustrates different levels of integration and the technology used to implement a particular level of integration.

TABLE 2

| Cooperative/Non- | Action | | Technology |
|---|---|---|---|
| Cooperative | Owners | Integration Level | Implemented |
| Cooperative Sites | Site owners | Tightly integrated | Web Service |
| | | (Level Two) | |
| | | Loosely integrated | Webpage Plug-in |
| | | (Level One) | JavaScript |
| Non-Cooperative | End-Users | No integration | Browser Add-On |
| Sites | | | |

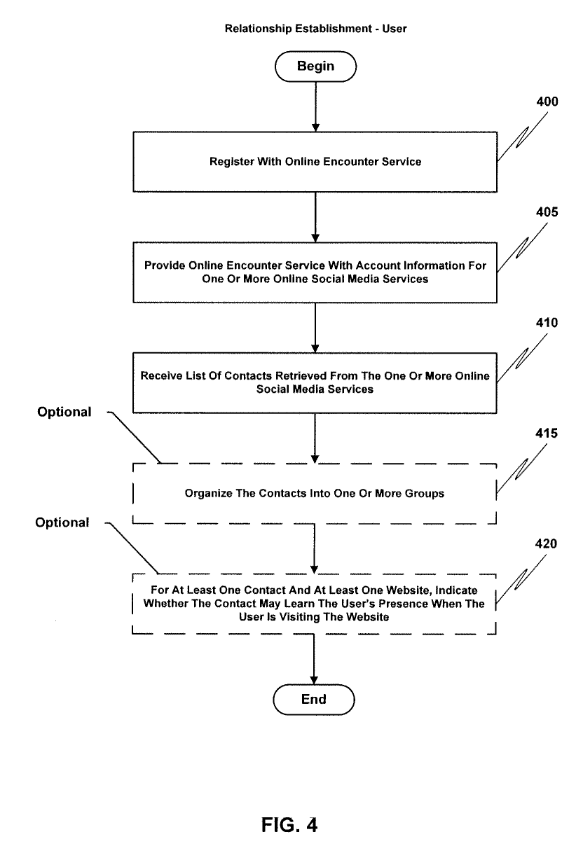

FIG. 4 is a flow diagram that illustrates a method for relationship establishment from a user's perspective in a system for online social encountering in accordance with one embodiment of the present invention. The processes illustrated in FIG. 4 may be implemented in hardware, software, or a combination thereof. At 400, a user registers with an online encounter service. At 405, the user provides the online encounter service with account information for one or more online social media services. At 410, the user receives a list of contacts received from one or more online social media services. At 415, the user optionally organizes the contacts into one or more groups. At 420, for at least one contact and at least one website, the user optionally indicates whether the contact may learn the user's presence when the user is visiting the website.

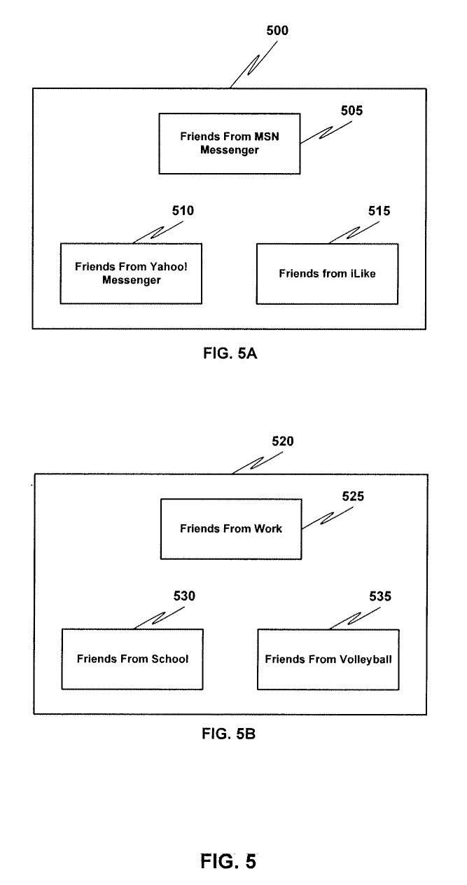

FIG. 5A is a block diagram that illustrates friend groupings based on third party social media service in accordance with one embodiment of the present invention. As shown in FIG. 5A, a user may group the user's friends according to the third party social service through which the user has indicated a relationship with the friend. For example, a user may group the users' friends 500 based on whether the relationship information was obtained from MSN Messenger 505, Yahoo! Messenger 510, or iLike 515.

FIG. 5B is a block diagram that illustrates friend groupings a user's real world association with the friends in accordance with one embodiment of the present invention. As shown in FIG. 5B, a user may group the user's friends according to the user's real world association with the friends. For example, a user may group the user's friends 520 based on whether the user knows the friends from work 525, from school 530, or from a recreational activity such as a volleyball league 535.

### Privacy Control

According to one embodiment of the present invention, one or more privacy controls are applied to limit availability of online social encountering. The controls may be used, for example, to control interactions with particular friends, friend groups, websites, or a combination thereof.

According to an embodiment of the present invention, the action of a privacy control is to block or automatically prevent a specific website or individual friend from social encountering.

According to another embodiment of the present invention, the action of a privacy control is to automatically allow a specific website or individual friend to participate in online social encountering.

According to an embodiment of the present invention, the action of a privacy control is to prompt a user as to whether to allow online social encountering for an individual friend or for a specific website.

According to another embodiment of the present invention, a “always allow” list comprises a list of websites which will automatically allow all friends to be encountered when a user is visiting a website in the list.

According to another embodiment of the present invention, a “always disallow” list comprises a list of websites which will automatically disallow friends to be encountered when a user is visiting a website in the list.

According to one embodiment of the present invention, a friend list is imported from each social media, and a user can configure the privacy control for each friend or group of friends.

According to one embodiment of the present invention, a user maintains list of websites to automatically block or to allow friends to be encountered. For example, a “white list” of websites includes a list of websites to automatically allow all friends to be encountered, a “black list” of websites includes a list of websites to automatically block all friends to be encountered. If a website is not found in the “white list” and the website is not found in the “black list,” a privacy control setting for each friend or friend group is used to determine whether friends may be encountered.

According to one embodiment of the present invention, the privacy control setting of a visited site is shown somewhere in the web pages or in the status line of the browser page to remind the user of the current privacy control setting. The user can change the setting in real time.

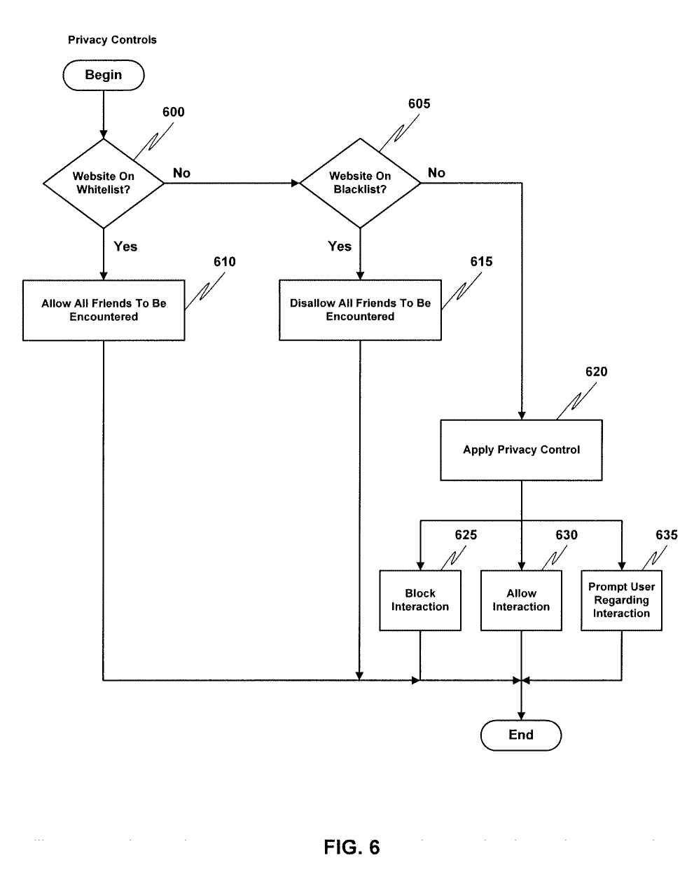

FIG. 6 is a flow diagram that illustrates privacy controls in a system for online social encountering in accordance with one embodiment of the present invention. At 600, a determination is made regarding whether a website is on a white list. If the website is on the white list, at 610 all friends are allowed to be encountered. If at 600 the website is not on the white list, at 605 a determination is made regarding whether the website is on a black list. If the website is on the black list, at 615 encountering of all friends is disallowed. If at 605 it is determined that the website is not on the black list, privacy controls are applied at 620. Depending on the particular privacy control applied, the result is either blocking interaction 625, allowing interaction 630, or prompting the user regarding the permitted interaction 635.

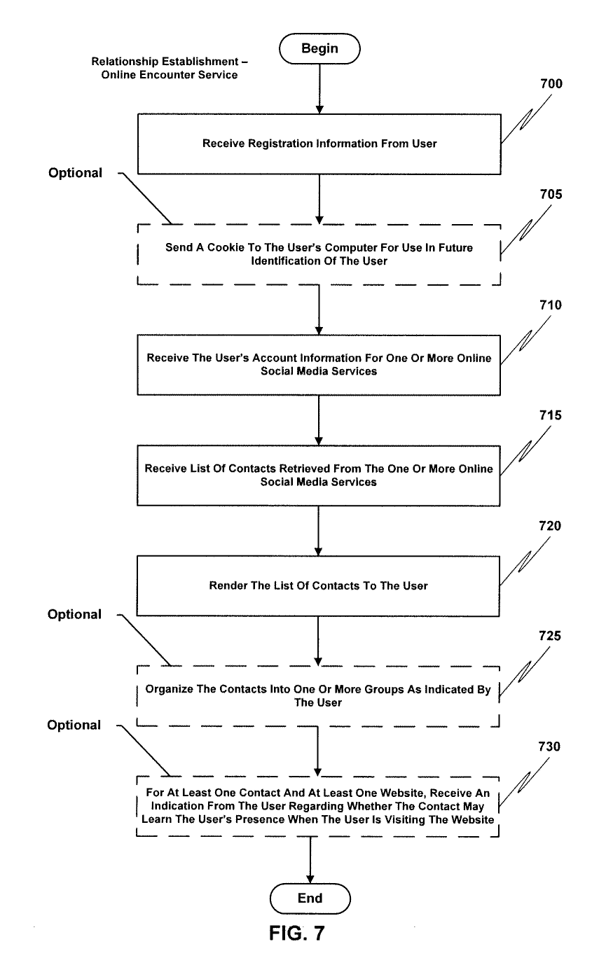

FIG. 7 is a flow diagram that illustrates a method for relationship establishment from the perspective of an online encounter service in a system for online social encountering in accordance with one embodiment of the present invention. The processes illustrated in FIG. 7 may be implemented in hardware, software, or a combination thereof. At 700, registration information is received from a user. At 705, a cookie is optionally sent to the user's computer for use in future identification of the user. At 710, the user's account information for one or more online social media services is received. At 715, a list of contacts retrieved from the one or more online social media services is received. The list of contacts may be retrieved on the user's behalf via one or more open APIs provided by the one or more online social media services. At 720, the list of contacts is rendered to the user. At 725, the contacts are optionally organized into one or more groups as indicated by the user. According to one embodiment of the present invention, the various groupings are maintained by the online encounter service and are not propagated to third party networks.

At 730, for at least one contact and at least one website, an indication from the user regarding whether the contact may learn the user's presence information when the user is visiting the website, is optionally received. A user may manage the user's privacy setting by configuring the user's relationship list against websites. Users can grant or reject their contacts to learn their presence information with all sites, or only those specified website. By indicating “All sites,” users allow their contacts to learn their presence on any website. By indicating “Specified website,” users allow their contacts to learn their presence on only those websites the users have specified. An online encounter server then stores the relationship list along with user's privacy setting against list of websites in an online encounter database. A user can choose to store their third party online social media identities via an online encounter service. In this way, an online encounter service can periodically pull the user's information from third party services to reflect the relationship changes users have made over different networks. If a user chooses not to have the online encounter service periodically pull the user's information from third party services, the online encounter service may store a timer both locally on the user's computer and in the encounter database so the presence client can remind users of the last time they updated their relationship information with the online encounter service.

### Presence Interaction

After a user receives notification of a presence status change, the user is able to interact with other users via instant messaging, voice chat, desktop sharing or co-browsing.

### Sign-In and Sign-Out

According to embodiments of the present invention, the term “Sign-in” refers to when a user logs on to an online encounter service by entering a valid user name and password on the online encounter service web portal. Other authentication methods are possible.

According to embodiments of the present invention, there are various alternative implementations of Sign-Out. Three example implementations are discussed below.

According to one embodiment of the present invention, when a user that is already signed in to the online encounter service chooses to sign out from the online encounter service, the online encounter service clears user identity information (e.g., cookies) from the user's computer. This scenario is suitable for users who are concerned about privacy, users with multiple identities with various social media networks and users who may share a computer with other people. In this scenario, such a user will need to sign-in to the online encounter service every time the user wants to enjoy an online social encountering experience.

According to another embodiment of the present invention, when a user that is already signed in to the online encounter service chooses to sign out from the online encounter service, the user opts to “Keep the service activated” even after the user signs out. A user that chooses this option continues to enjoy an online social encountering experience even after the user signs-out of the online encounter service. In this scenario, the user identity information is not cleared from the user's computer. If the user chooses not to “Keep the service activated,” the online encounter service clears user identity information (e.g., cookies) from the user's computer. This scenario is suitable for users who want to choose whether to erase the user's identity information upon exiting the online encounter service. This scenario provides a user with the flexibility to determine how the online encounter service is used, depending on the particular environment that the user is in.

According to another embodiment of the present invention, when a user that is already signed in to the online encounter service chooses to sign out from the online encounter service, the online encounter service automatically keeps the user's identity information on the user's computer, such that the user will no longer be required to sign back in to the online encounter service the next time the wants to use the service. This scenario is suitable for users with dedicated computers and who are less concerned about privacy.

When the term “sign-in” or “sign-out” is used in the paragraphs below, it can take on any of the implementations described above.

### “Sign Out” in Browser Add-On Implementation.

According to one embodiment of the present invention, a user downloads and installs a browser add-on and registers an account with an online encounter service. Once the user signs in to the online encounter service, the user's identity information is stored locally in a folder on the user's computer where the add-on is installed. After the user is signed in to the online encounter service, the user can choose to remain “signed in,” or the user can “sign-out,” depending on how the user wants to use the service in the future. The online encounter service will either clear or retain the user identity information on user's computer accordingly.

### “Sign Out” in Webpage Plug-In Implementation

According to another embodiment of the present invention, upon visiting a web page with an online encounter service plug-in embedded therein, a is be asked to download the plug-in, install the plug-in, and register an account with the online account service if the user has not done so already. If user has downloaded and installed the component from site-A, the user is NOT asked to download and install the component again on site-B. Once the user signs in with the user's online encounter service account from the webpage plug-in, the user's identity information is stored locally in a folder on the user's computer where the plug-in is installed. After the user is signed in to the online encounter service, the user can choose to remain “signed in,” or the user can “sign-out” depending on how the user wants to use the service in the future. The online encounter service will either clear or retain the user identity information on user's computer accordingly.

### “Sign Out” in Embedded JavaScript Implementation

According to another embodiment of the present invention, upon visiting a web page with online encounter service JavaScript embedded therein, a user is asked to register an account with the online encounter service if the user has not done so previously. After a user registers and signs in with the online encounter service, the user's identity information is stored locally in the form of browser cookie. After the user is signed in to the online encounter service, the user can choose to remain “signed in,” or the user can “sign out,” depending on how the user wants to use the service in the future. The online encounter service will either clear or retain the user browser cookie information on user's computer accordingly. The user can also choose to manually clear the user's browser cookies, and in this case, the user will be required to sign back in to the online encounter service if the user wants to use the service in the future.

### “Sign Out” in Web Service Implementation

According to another embodiment of the present invention, a web service of a website (e.g. Macys.com web service) signs up for online encounter service for the users of the website. Macys.com has all of its user identity information and such information can be stored in the database. Macys.com initiates the presence interaction and the online encounter service has no knowledge of how and where the user's information is stored. The online encounter service passively processes the information it receives from Macys.com.

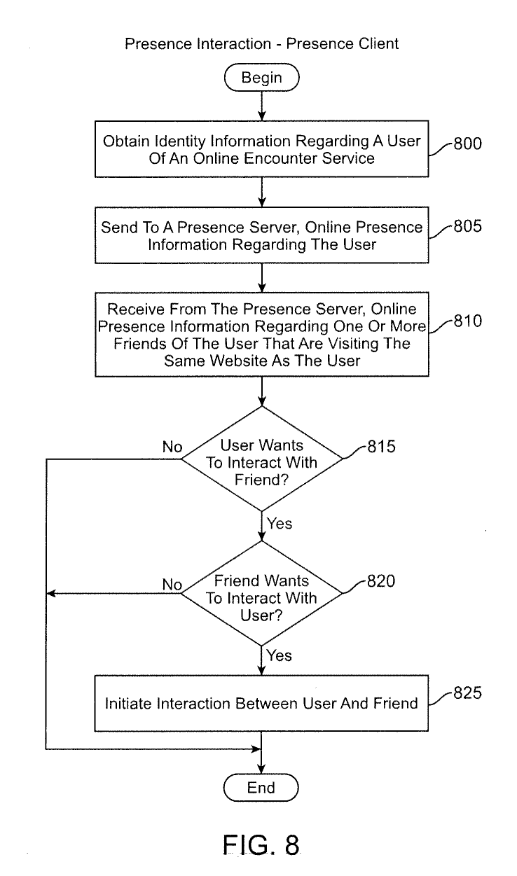

FIG. 8 is a flow diagram that illustrates a method for presence interaction from the perspective of a presence client in a system for online social encountering in accordance with one embodiment of the present invention. The processes illustrated in FIG. 8 may be implemented in hardware, software, or a combination thereof. At 800, identity information regarding a user of an online encounter service is obtained. After a user registers with the online encounter service, the user's identity information may stored differently depending on the implementation of the presence client. The identity information may be stored locally until a user specifies a different storage location. Various ways of retrieving identity information are discussed below.

### Retrieval of Identity Information via Browser Add-On

According to one embodiment of the present invention, a presence client attempts to find online encounter service identity information on a user's local computer. If the presence client finds such information, the presence client may prompt the user to confirm the online encounter service identity. If the presence client cannot find the identity information, the presence client prompts the user to sign in to the online encounter service, or to register an account with the online encounter service.

### Retrieval of Identity Information via Webpage Plug-In

According to another embodiment of the present invention, a presence client attempts to find online encounter service identity information on a user's local computer as described above. If the presence client finds such information, it may prompt the user to confirm the online encounter service identity. The option is configurable depending on user's preference. If the presence client cannot find the identity information, the presence client will ask the user to sign in to the online encounter service, or to register an account with the online encounter service.

### Retrieval of Identity Information via Embedded JavaScript

According to another embodiment of the present invention, a presence client with embedded JavaScript attempts to find an online encounter service cookie on a user's local computer as described above. If the presence client finds such information, it may prompt the user to confirm the online encounter service identity. The option is configurable depending on user's preference. If the presence client cannot find the identity information, the presence client will ask the user to sign in to the online encounter service, or to register an account with the online encounter service.

### Retrieval of Identity Information via Web Service

According to another embodiment of the present invention, a web server of a website (e.g. Macys.com web server) learns a user's identity either from the user's existing cookie or upon user sign in. The Macys.com web server then can pass user identity information to its presence web service.

Referring again to FIG. 8, after identity information regarding a user of an online encounter service is obtained, at 805, online presence information regarding the user is delivered to a presence server. Upon a user visiting a webpage, a presence client delivers the “online” presence information to the presence server. “Online” presence information includes user identity information, user IP address, website address that this user is currently visiting, and webpage title and URL. A default presence status indicates whether the user is “online” or “offline” with respect to a particular website. When a user leaves a website or closes a window or signing out from the service, a presence client will deliver “offline” presence information to the presence server. “Offline” presence information includes user identity information, website address and webpage URL. Various ways of delivering presence information to a presence server are discussed below.

### Presence Information Delivery via Browser Add-On.

According to one embodiment of the present invention, a presence client sends the website and webpage information to a presence server. Webpage information includes webpage title and URL the users are visiting.

### Presence Information Delivery via Webpage Plug-In

According to one embodiment of the present invention, a webpage plug-in sends the website and webpage information to presence server. Webpage information includes webpage title and URL the users are visiting.

### Presence Information Delivery via Embedded JavaScript

According to one embodiment of the present invention, embedded JavaScript code sends the website and webpage information to a presence server. Webpage information includes webpage title and URL the users are visiting.

### Presence Information Delivery via Web Service

According to one embodiment of the present invention, a cooperative website (e.g. Macys.com) defines its own presence status. Macys.com sends a user's presence status information to an online encounter presence server.

Referring again to FIG. 8, at 810, after online presence information regarding the user is delivered to a presence server, online presence information regarding one or more friends of the user that are visiting the same website as the user is received from the presence server. At 815, a determination is made regarding whether the user wants to interact with a particular friend, if the determination indicates the user wants to interact with the friend, at 820 a determination is made regarding whether the friend wants to interact with the user. If at 820 it is determined that the friend wants to interact with the user, at 825 interaction between the user and the friend is initiated.

For example, if User-B is online, and User-A allows User-B to interact with him and vise versa, and website presence conditions are met, User-B will receive a presence change notification. User-B can also learn of a change in User-A's presence status through the presence list and optional notifications through toast window. The user can configure such notifications to enable or disable the notifications. Various ways of receiving online presence information regarding one or more friends of the user that are visiting the same website as the user are discussed below.

### Notification of Presence Status Change via Browser Add-On.

User-A's presence client will have a balloon notification of User-B's presence status change. Such information is reflected in the “buddy list” as well. By clicking on a “buddy list” button of the presence client browser add-on, all the website names along with the friends that are currently online at the specific site are presented to the user.

### Notification of Presence Status Change via Webpage Plug-In

According to one embodiment of the present invention, a webpage plug-in is configured to provide a balloon notification of a user's presence status change. Such information is reflected in the “buddy list” as well. When a “buddy list” button is clicked, the webpage plug-in lists all the website names along with the friends that are currently online at the specific site.

### Notification of Presence Status Change via Embedded JavaScript

According to one embodiment of the present invention, upon receiving a presence change notification a presence client implemented with JavaScript makes any necessary client side change, such as presence list changes and notifications, using AJAX. Upon clicking a “buddy list” button, the Embedded JavaScript lists all the website names, along with the friends that are currently online at the specific site.

### Notification of Presence Status Change via Web Service

According to one embodiment of the present invention, a cooperative website (e.g. Macys.com) has complete control over how presence information is presented to users. For example, Macys.com could present presence information by displaying it as text, an image file, etc.

According to one embodiment of the present invention, when User-A clicks on User-B in User-A's buddy list, interaction between User-A and User-B is initiated. The interaction can be via instant messaging, desktop sharing, co-browsing, or the like. The interaction may take place via a peer-to-peer mechanism if the presence server determines such an interaction is possible. The presence server may determine whether such an interaction is allowed. If a peer-to-peer interaction is not allowed, a media relay server can be used to relay the traffic. PSipTN, a SIP network, by TelTel is an example implementation of this architecture.

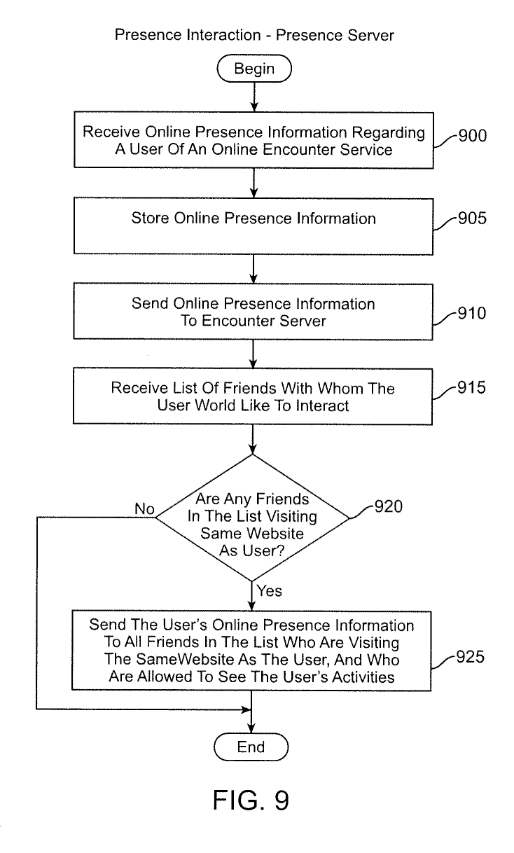

FIG. 9 is a flow diagram that illustrates a method for presence interaction from the perspective of a presence server in a system for online social encountering in accordance with one embodiment of the present invention. The processes illustrated in FIG. 9 may be implemented in hardware, software, or a combination thereof. At 900, online presence information regarding a user of an online encounter service is received. The presence information includes site identity, user identity and user presence status. At 905, the online presence information is stored. The presence information may be stored locally in a presence server cache, in a persistent database (“Presence DB”), or both. At 910, the online presence information is sent to an encounter server.

The encounter server retrieves User-A's relationship and privacy setting, chooses those friends User-A would like to interact with, and passes the list along to the presence server. The presence server utilizes the list from encounter server and cross-checks its presence list to determine whether any friend of User-A is currently visiting the same website that User-A is visiting. The presence server then passes the presence information to User-A's friends who are allowed to see User-A's activities on this website. The presence server receives and sends out notification of all users' presence information each time the user visits the webpage. If presence information has not been changed for more than a predetermined time (an optional timer may be configured by an online encounter service), the presence session is expired and the presence server sends an offline notification to the user's friends who are allowed to see their activities on this website.

Referring again to FIG. 9, at 915, a list of friends the user would like to interact with is received. At 920, a determination is made regarding whether there are any friends in the list that are visiting the same website as the user. If at 920 it is determined that there are one or more friends in the list that are visiting the same website as the user, at 925 the user's online presence information is sent to all friends in the list who are visiting the same website as the user, and who are allowed to see the other user's activities.

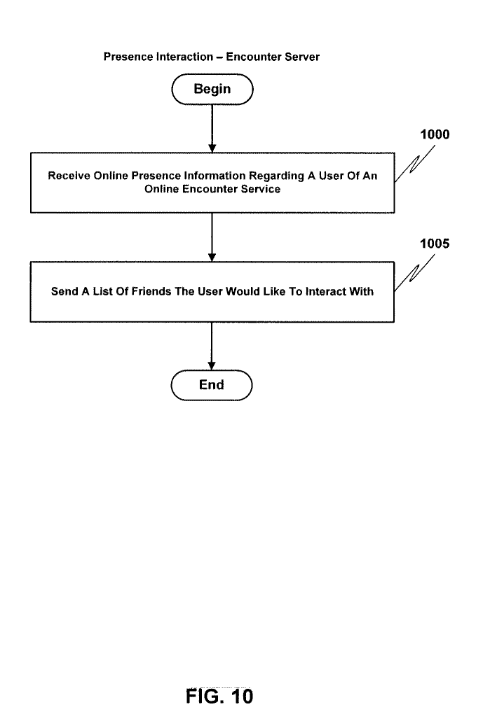

FIG. 10 is a flow diagram that illustrates a method for presence interaction from the perspective of an encounter server in a system for online social encountering in accordance with one embodiment of the present invention. The processes illustrated in FIG. 10 may be implemented in hardware, software, or a combination thereof. At 1000, online presence information regarding a user of an online encounter service is received. At 1005, a list of friends with whom the user would like to interact is sent.

According to one embodiment of the present invention, a user is informed of the presence status of the user's friends through an online encounter notification mechanism. This may be implemented via a pop-up toast on a user's computer, such that a pop-up toast appears on the user's computer when the presence status of friend of the user changes.

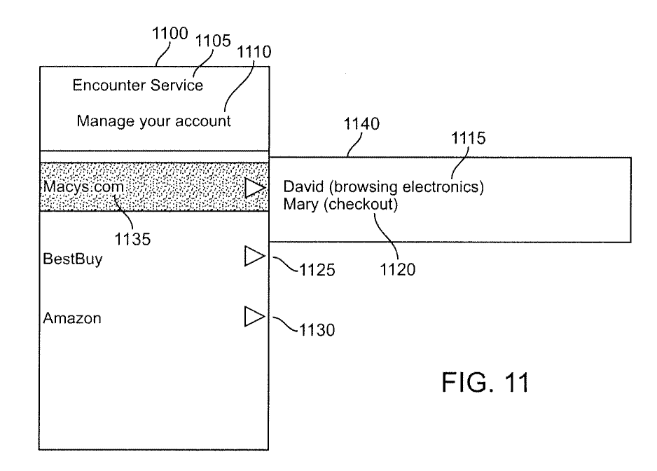

FIG. 11 is a block diagram that illustrates a presence list in accordance with one embodiment of the present invention. Users can find an online social encountering experience through a presence list. When a user clicks on a presence list button, a list of websites that the user is visiting is displayed (1100), and a friend list 1140 is displayed on the next level of the menu. For example, if a user is browsing Macys.com 1135 and Amazon.com 1130 at the same time while the user's friend A is visiting Macys.com, the list will show Macys.com with friend A on the next level of the list (1140) and Amazon.com with no one on the next level of the list. When user mouses over friend A on the list (1140), the user will see which social network A is from, as well as friend A's unique ID on that social network.

According to one embodiment of the present invention, a tightly integrated cooperative website has status information regarding the users friends who are visiting the same website as the user. For example, the “browsing electronics” text 1115 indicates the user David is currently browsing electronics at Macys.com. In the mouse-over scenario, when a user mouses over “David (browsing electronics),” an indication of the online social media service through which the user knows the friend, is displayed. For example, if the user knows David from Facebook, the user will see “Facebook, david@gmail.com.”

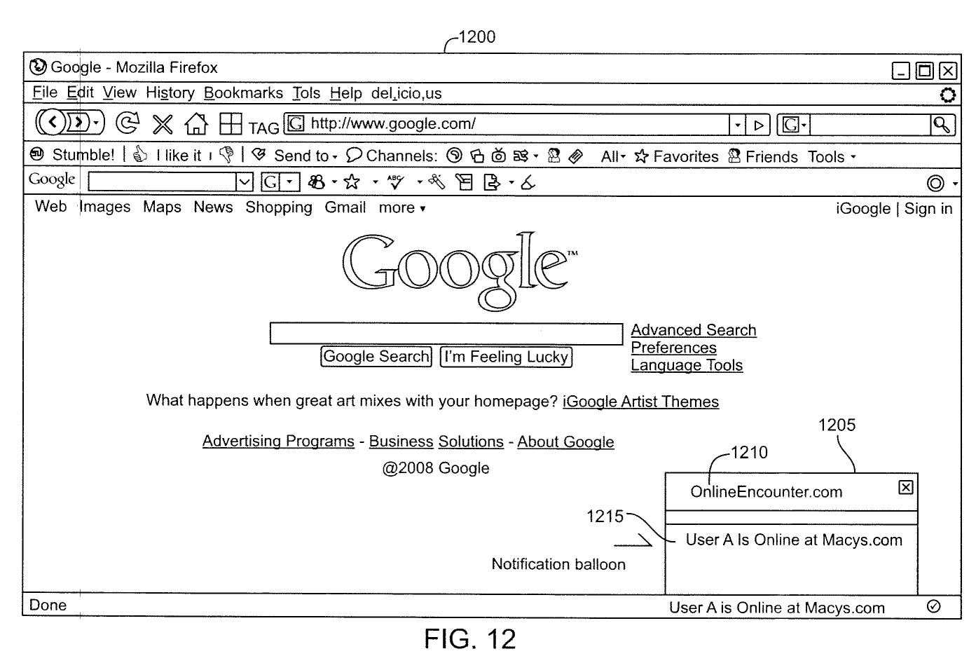

FIG. 12 is a block diagram that illustrates a presence notification balloon in accordance with one embodiment of the present invention. As shown in FIG. 12, notification balloon 1205 appears upon a change in online presence information regarding a user's friends. In the example illustrated in FIG. 12, notification balloon 1205 indicates that one of a user's friends (User A), is not online at the website Macys.com.

According to one embodiment of the present invention, an online encounter service management portal provides features such as account management, configuration, and relationship information organization. Configurations made by a user to manage privacy on the online encounter service are not propagated to the settings of the user's existing social networks. The management portal also includes, for each registered user, the user's privacy control for each of the user's social network against individual websites. The user can also set up privacy controls to allow or block online social encountering based on the identity of buddies in the user's allowed social networks or based on the identity of the websites.

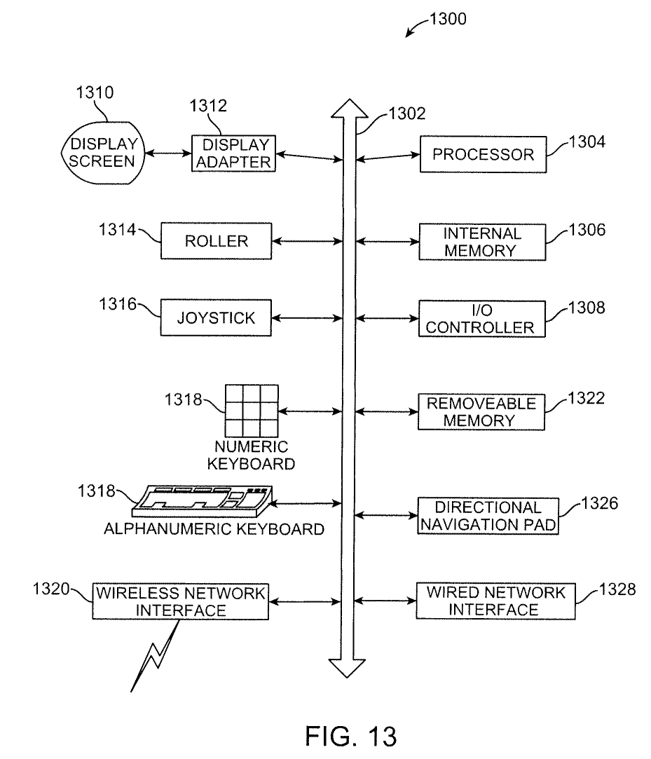

FIG. 13 depicts a block diagram of a computer system 1300 suitable for implementing aspects of the present invention. As shown in FIG. 13, system 1300 includes a bus 1302 which interconnects major subsystems such as a processor 1304, an internal memory 1306 (such as a RAM), an input/output (I/O) controller 1308, a removable memory (such as a memory card) 1322, an external device such as a display screen 1310 via display adapter 1312, a roller-type input device 1314, a joystick 1316, a numeric keyboard 1318, an alphanumeric keyboard 1318, directional navigation pad 1326 and a wireless interface 1320. Many other devices can be connected. Wireless network interface 1320, wired network interface 1328, or both, may be used to interface to a local or wide area network (such as the Internet) using any network interface system known to those skilled in the art.

Many other devices or subsystems (not shown) may be connected in a similar manner. Also, it is not necessary for all of the devices shown in FIG. 13 to be present to practice the present invention. Furthermore, the devices and subsystems may be interconnected in different ways from that shown in FIG. 13. Code to implement the present invention may be operably disposed in internal memory 1306 or stored on storage media such as removable memory 1322, a floppy disk, a thumb drive, a CompactFlash® storage device, a DVD-R (“Digital Versatile Disc” or “Digital Video Disc”-Recordable), a DVD-ROM (“Digital Versatile Disc” or “Digital Video Disc” read-only memory), a CD-R (Compact Disc-Recordable), or a CD-ROM (Compact Disc read-only memory).

While embodiments and applications of this invention have been shown and described with respect to online social encountering, embodiments of the present invention apply more broadly to presence on any type of computer network, including the Internet or a LAN communicatively coupled using protocols including, for example, HTTP, SIP, and FTP.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method comprising:
obtaining identity information regarding a user of an online encounter service;
sending to a presence server, online presence information regarding the user;
receiving from the presence server, online presence information regarding one or more friends of the user that are visiting a website that the user is also visiting; and
if the user and the one or more friends indicate they desire to interact, initiating an interaction between the user and the one or more friends.

2. The method of claim 1 wherein the online presence information regarding the user comprises:
an identification of the user;
an identification of one or more websites that the user is visiting; and
a presence status of the user.

3. The method of claim 1 wherein the interaction comprises one of instant messaging, voice chat, desktop sharing, and co-browsing.

4. The method of claim 1, further comprising, after the receiving, notifying the user of the one or more friends.

5. The method of claim 4 wherein the notifying comprises displaying to the user via a pop-up toast, information regarding the one or more friends.

6. The method of claim 5 wherein the information comprises one or more of:
an identification of the one or more friends;
an indication of one or more websites being visited by the one or more friends; and
an indication of a social network associated with the one or more friends.

7. A method comprising:
receiving online presence information regarding a user of an online encounter service;
storing the online presence information;
sending the online presence information to an encounter server;
receiving an indication of one or more friends with whom the user would like to interact; and
if at least one of the one or more friends are visiting the same website as the user, and if the at least one of the one or more friends are allowed to view online activities of the user, sending the online presence information to the at least one of the one or more friends.

8. The method of claim 7 wherein the online presence information regarding the user comprises:
an identification of the user;
an identification of one or more websites that the user is visiting; and
a presence status of the user.

9. The method of claim 7 wherein the storing comprises storing the online presence information locally in a presence server cache.

10. The method of claim 7 wherein the storing comprises storing the online presence information locally in a persistent database.

11. The method of claim 7 wherein the storing comprises storing the online presence information locally in a presence server cache and storing the online presence information locally in a persistent database.

12. A method comprising:
receiving online presence information regarding a user of an online encounter service; and
sending an indication of one or more friends with whom the user would like to interact when the user and at least one of the one or more friends are visiting the same website.

13. The method of claim 12 wherein the online presence information regarding the user comprises:
an identification of the user;
an identification of one or more websites that the user is visiting; and a presence status of the user.

14. The method of claim 12 wherein the indication of one or more friends with whom the user would like to interact is obtained from one or more third party social media services.

15. The method of claim 14 wherein the one or more third party social media services comprises an instant messaging service, an online social network service, or a social bookmarking network service.

16. The method of claim 12, further comprising:
before the sending, applying one or more privacy controls to for the user, the one or more privacy controls limiting the availability of online social encountering.

17. The method of claim 16 wherein the one or more privacy controls indicate online social encountering at one or more particular websites should be blocked.

18. The method of claim 16 wherein the one or more privacy controls indicate online social encountering at one or more particular websites should be allowed.

19. The method of claim 16 wherein the one or more privacy controls indicate online social encountering with one or more particular friends or friend groups should be blocked.

20. The method of claim 16 wherein the one or more privacy controls indicate online social encountering with one or more particular friends or friend groups should be allowed.

21. An apparatus comprising:
a memory; and
a processor configured to:
obtain identity information regarding a user of an online encounter service;
send to a presence server, online presence information regarding the user;
receive from the presence server, online presence information regarding one or more friends of the user that are visiting a website that the user is also visiting; and
if the user and the one or more friends indicate they desire to interact, initiate an interaction between the user and the one or more friends.

22. The apparatus of claim 21 wherein the online presence information regarding the user comprises:
an identification of the user;
an identification of one or more websites that the user is visiting; and
a presence status of the user.

23. The apparatus of claim 21 wherein the interaction comprises one of instant messaging, voice chat, desktop sharing, and co-browsing.

24. The apparatus of claim 21 wherein the processor is further configured to, after the receiving, notify the user of the one or more friends.

25. The apparatus of claim 24 wherein the processor is further configured to display to the user via a pop-up toast, information regarding the one or more friends.

26. The apparatus of claim 25 wherein the information comprises one or more of:
an identification of the one or more friends;
an indication of one or more websites being visited by the one or more friends; and
an indication of a social network associated with the one or more friends.

27. An apparatus comprising:
a memory; and
a processor configured to:
receive online presence information regarding a user of an online encounter service;
store the online presence information;
send the online presence information to an encounter server;
receive an indication of one or more friends with whom the user would like to interact; and
if at least one of the one or more friends are visiting the same website as the user, and if the at least one of the one or more friends are allowed to view online activities of the user, send the online presence information to the at least one of the one or more friends.

28. The apparatus of claim 27 wherein the online presence information regarding the user comprises:
an identification of the user;
an identification of one or more websites that the user is visiting; and
a presence status of the user.

29. The apparatus of claim 27 wherein the processor is further configured to store the online presence information locally in a presence server cache.

30. The apparatus of claim 27 wherein the processor is further configured to store the online presence information locally in a persistent database.

31. The apparatus of claim 27 wherein the processor is further configured to store the online presence information locally in a presence server cache and to store the online presence information locally in a persistent database.

32. An apparatus comprising:
a memory; and
a processor configured to:
receive online presence information regarding a user of an online encounter service; and
send an indication of one or more friends with whom the user would like to interact when the user and at least one of the one or more friends are visiting the same website.

33. The apparatus of claim 32 wherein the online presence information regarding the user comprises:
an identification of the user;
an identification of one or more websites that the user is visiting; and
a presence status of the user.

34. The apparatus of claim 32 wherein the indication of one or more friends with whom the user would like to interact is obtained from one or more third party social media services.

35. The apparatus of claim 34 wherein the one or more third party social media services comprises an instant messaging service, an online social network service, or a social bookmarking network service.

36. The apparatus of claim 32 wherein the processor is further configured to, before the sending, apply one or more privacy controls to for the user, the one or more privacy controls limiting the availability of online social encountering.

37. The apparatus of claim 36 wherein the one or more privacy controls indicate online social encountering at one or more particular websites should be blocked.

38. The apparatus of claim 36 wherein the one or more privacy controls indicate online social encountering at one or more particular websites should be allowed.

39. The apparatus of claim 36 wherein the one or more privacy controls indicate online social encountering with one or more particular friends or friend groups should be blocked.

40. The apparatus of claim 36 wherein the one or more privacy controls indicate online social encountering with one or more particular friends or friend groups should be allowed.

41. An apparatus comprising:
means for obtaining identity information regarding a user of an online encounter service;
means for sending to a presence server, online presence information regarding the user;
means for receiving from the presence server, online presence information regarding one or more friends of the user that are visiting a website that the user is also visiting; and
means for, if the user and the one or more friends indicate they desire to interact, initiating an interaction between the user and the one or more friends.

42. An apparatus comprising:
means for receiving online presence information regarding a user of an online encounter service;
means for storing the online presence information;
means for sending the online presence information to an encounter server;
means for receiving an indication of one or more friends with whom the user would like to interact; and
means for, if at least one of the one or more friends are visiting the same website as the user, and if the at least one of the one or more friends are allowed to view online activities of the user, sending the online presence information to the at least one of the one or more friends.

43. An apparatus comprising:
means for receiving online presence information regarding a user of an online encounter service; and
means for sending an indication of one or more friends with whom the user would like to interact when the user and at least one of the one or more friends are visiting the same website.

44. A program storage device readable by a machine, embodying a program of instructions executable by the machine to perform a method, the method comprising:
obtaining identity information regarding a user of an online encounter service;
sending to a presence server, online presence information regarding the user;
receiving from the presence server, online presence information regarding one or more friends of the user that are visiting a website that the user is also visiting; and
if the user and the one or more friends indicate they desire to interact, initiating an interaction between the user and the one or more friends.

45. A program storage device readable by a machine, embodying a program of instructions executable by the machine to perform a method, the method comprising:
receiving online presence information regarding a user of an online encounter service;
storing the online presence information;
sending the online presence information to an encounter server;
receiving an indication of one or more friends with whom the user would like to interact; and
if at least one of the one or more friends are visiting the same website as the user, and if the at least one of the one or more friends are allowed to view online activities of the user, sending the online presence information to the at least one of the one or more friends.

46. A program storage device readable by a machine, embodying a program of instructions executable by the machine to perform a method, the method comprising:
receiving online presence information regarding a user of an online encounter service; and
sending an indication of one or more friends with whom the user would like to interact when the user and at least one of the one or more friends are visiting the same website.
